(19) United States
(12) Patent Application Publication
(10) Pub. No.: US 2022/0193829 A1
(43) Pub. Date: Jun. 23, 2022

(54) MANUFACTORING METHOD OF DISPLAY DEVICE

(71) Applicant: Samsung Display Co., Ltd., Yongin-si (KR)

(72) Inventors: Cheol Min Park, Hwaseong-si (KR); Byung Hoon Kang, Seoul (KR); Seung Kim, Seongnam-si (KR); Seung Ho Kim, Asan-si (KR); Woo Suk Seo, Yongin-si (KR); Hoi Kwan Lee, Suwon-si (KR)

(21) Appl. No.: 17/479,457

(22) Filed: Sep. 20, 2021

(30) Foreign Application Priority Data
Dec. 22, 2020 (KR) 10-2020-0181123

(51) Int. Cl. B23K 26/40; B23K 26/364

(52) U.S. Cl. CPC B23K 26/40; B23K 26/364

(57) ABSTRACT

A manufacturing method of a display device includes: forming a laminate by laminating resins on first and second side surfaces of a glass; removing the resins along a laser irradiation line by irradiating a laser on the laminate; separating the laminate into a plurality of laminates by performing primary etching using an etching liquid composition; vertically stacking the plurality of laminates; and performing secondary chemical etching on a structure formed by stacking the plurality of laminates.

### CROSS-REFERENCE TO RELATED APPLICATION

This application claims priority from and the benefit of Korean Patent Application No. 10-2020-0181123, filed on Dec. 22, 2020, which is hereby incorporated by reference for all purposes as if fully set forth herein.

### BACKGROUND

### Field

Embodiments of the invention relate generally to a manufacturing method of a display device, and more specifically, to a manufacturing method of glass for a display device.

### Discussion of the Background

Recently, various mobile electronic devices such as portable phones, navigation systems, digital cameras, electronic books, portable game machines, or various terminals applied with display devices such as liquid crystal display (LCD) devices or organic light emitting display (OLED) devices are being used.

In a typical display device used in such a mobile electronic device, a cover window may be provided transparently, such as one being formed with glass, so that a user can see a display portion in front of the display panel. Since the cover window is formed on the outermost part of the display device, it must be strong against external impact to protect the display panel inside the display device.

In addition, instead of conventional electronic devices that used a switch or keyboard as an input device, recently, a structure that uses a touch panel that is integrated with a display screen has become widespread, and thus, compared to the conventional mobile devices, the surface of the cover window is more frequently in contact with fingers and the like and accordingly, the cover window with a stronger strength is required.

In addition, as a display device becomes thinner, the thickness of the cover window also becomes thinner, and such a thin cover window is not easy to handle in the manufacturing process.

The above information disclosed in this Background section is only for understanding of the background of the inventive concepts, and, therefore, it may contain information that does not constitute prior art.

### SUMMARY

Methods according to illustrative embodiments are capable of providing a sturdy cover window for a display device so as to be resistant to impacts provided to front and side surfaces of the cover window.

Embodiments are to provide a manufacturing method of glass that is resistant to breakage by having a constant curvature on a side surface of the glass.

Additional features of the inventive concepts will be set forth in the description which follows, and in part will be apparent from the description, or may be learned by practice of the inventive concepts.

A manufacturing method of a display device according to an embodiment includes: forming a laminate by laminating resins on first and second side surfaces of a glass; removing the resins along a laser irradiation line by irradiating a laser on the laminate; separating the laminate into a plurality of laminates by performing primary etching using an etching liquid composition; vertically stacking the plurality of laminates; and performing secondary chemical etching on a structure formed by stacking the plurality of laminates.

In the removing of the resins by irradiating the laser on the laminate, a plurality of grooves may be formed on the glass along the laser irradiation line.

In the removing of the resins by irradiating the laser on the laminate, physical properties of the glass may be changed along the laser irradiation line.

After the separating the laminate into a plurality of laminates by primary etching the laminate using the etching liquid composition, a curvature radius of a side surface of the glass may be larger than a curvature radius of a side surface of the glass after the second spinning etching is performed on the structure on which the plurality of laminates are stacked.

In the separating the laminate into the plurality of laminates through primary etching by using the etching liquid composition, a curvature radius of a side surface of the glass may be larger than a thickness of the glass.

After the performing of the secondary chemical etching on the structure formed by stacking the plurality of laminates, a difference between a curvature radius of a side surface of the glass and a thickness of the glass may be within 10%.

A thickness of the glass may be about 30 μm to about 100 μm.

The manufacturing method of the display device may further include, after the performing of the secondary chemical etching on the structure formed by stacking the plurality of laminates, separately separating the glass by removing the resin from the structure.

A manufacturing method of a display device according to another embodiment includes: forming a laminate by laminating resins on first and second side surfaces of a glass; removing the resins along a laser irradiation line by irradiating a laser on the laminate; separating the laminate into a plurality of laminates by performing primary etching using an etching liquid composition; and removing the resin from the laminate.

In the removing of the resins by irradiating the laser on the laminate, a plurality of grooves may be formed on the glass along the laser irradiation line.

In the removing of the resins by irradiating the laser on the laminate, physical properties of the glass may be changed along the laser irradiation line.

In the separating the laminate into the plurality of laminates through primary etching by using the etching liquid composition, a curvature radius of a side surface of the glass may be larger than a thickness of the glass.

A thickness of the glass may be about 30 μm to about 100 μm.

A manufacturing method of a display device according to another embodiment includes: irradiating a glass with a laser; and separating the glass irradiated with the laser into a plurality of pieces by performing etching using an etching liquid composition.

In the irradiating the glass with a laser, a plurality of grooves may be formed in the glass along a laser irradiation line.

In the irradiating the glass with a laser, physical properties of the glass may be changed along the laser irradiation line.

The manufacturing method of the display device may further include, after the separating the glass into the plurality of pieces by etching the laser-irradiated glass with the etching liquid composition, performing secondary etching on the separated individual glass.

After performing the secondary etching on the separated individual glass, a difference between a curvature radius of a side of the glass and a thickness of the glass may be within 10%.

The separated individual glass may be secondarily etched by spinning etching.

A thickness of the glass may be about 30 μm to about 100 μm.

According to the embodiments, a manufacturing method of glass of which a side surface of the glass has a constant curvature, and thus is resistant to breakage when an impact is made to the side surface of the glass.

It is to be understood that both the foregoing general description and the following detailed description are illustrative and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate illustrative embodiments of the invention, and together with the description serve to explain the inventive concepts.

FIG. 1 is a schematic flowchart of a manufacturing process of glass according to an embodiment.

FIG. 2 illustrates a glass where resins are laminated.

FIG. 3 illustrates a configuration of removal of the resin through laser irradiation.

FIG. 4 illustrates a configuration where the physical properties of the glass are changed after laser irradiation.

FIG. 5 illustrates a primary chemical etching process.

FIG. 6 illustrates the shape of the laminate when being injected into the chamber.

FIG. 7 shows a shape of the laminate when being injected into the chamber.

FIG. 8 shows the shape of the laminate after the primary chemical etching.

FIG. 9 shows the separated laminate after the primary chemical etching.

FIG. 10 illustrates only the glass in the laminate 300 of FIG. 9.

FIG. 11 illustrates a structure where a plurality of laminates are stacked.

FIG. 12 illustrates a secondary chemical spinning etching process.

FIG. 13 illustrates the laminate 300 after the secondary chemical etching.

FIG. 14 illustrates only the glass in the laminate 300 of FIG. 13.

FIG. 15 illustrates a side impact damage test.

FIG. 16 is a side view of the impact damage test.

FIG. 17 illustrates results of the impact damage test of FIG. 15 and FIG. 16 performed on glass having various side shapes.

FIG. 18 illustrates the same experiment after tilting glasses, respectively having sides of Embodiment 1, Embodiment 2, and Embodiment 3, after tilting the glass at 10 degrees.

FIG. 19 is a flowchart that simply shows a manufacturing process of glass according to another embodiment.

FIG. 20 illustrates a glass where a resin is removed.

FIG. 21 illustrates a side of the glass 100 manufactured according to the embodiment of FIG. 19.

FIG. 22 is a flowchart of a manufacturing process of glass according to another embodiment.

FIG. 23 illustrates a laser irradiation process.

FIG. 24 shows a configuration in which grooves are formed in the glass after the laser irradiation.

FIG. 25 shows a configuration of the glass of which the physical properties are changed after laser irradiation.

FIG. 26 illustrates a process of primary chemical etching.

FIG. 27 illustrates the shape of the glass when being injected into the chamber.

FIG. 28 shows the shape of the glass after the primary chemical etching.

FIG. 29 shows separated glass after the primary chemical etching.

FIG. 30 illustrates the glass of FIG. 29.

FIG. 31 illustrates a secondary etching process performed on the primarily etched glass.

FIG. 32 illustrates the glass after the secondary etching of FIG. 31.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing illustrative features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Hereinafter, a manufacturing method of a display device according to an embodiment will be described with reference to the accompanying drawings. The present invention relates to a manufacturing method of glass in a display device.

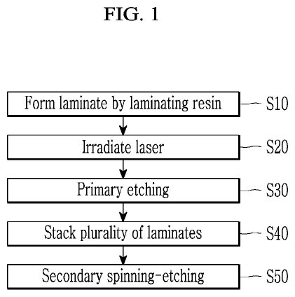

FIG. 1 is a schematic flowchart of a manufacturing process of glass according to an embodiment. Referring to FIG. 1, a glass manufacturing process according to an embodiment includes: forming a laminate by laminating a resin in upper and lower portions of glass (S10), removing the resin and forming a groove in the glass or changing physical properties by irradiating a laser (S20); cutting the laminate by performing primary chemical etching (S30); laminating a plurality of laminates (S40); and performing secondary chemical spinning-etching (S50). As shown in FIG. 1, the glass manufacturing process according to an embodiment may form a side surface of the glass to be curved close to the positive curvature through the primary and secondary etching after laser irradiation.

Hereinafter, the glass manufacturing process according to an embodiment will be described in detail.

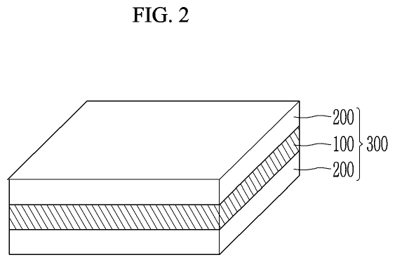

FIG. 2 illustrates a glass 100 where resins 200 are laminated. Referring to FIG. 2, the resins 200 are formed in the top and bottom surface of the glass 100 such that a laminate 300 is formed. The glass 100 formed in an embodiment has a thickness of about 30 μm to 100 μm, and thus the resins 200 may be provided above and below the glass 100 to prevent breakage and facilitate handling during the process.

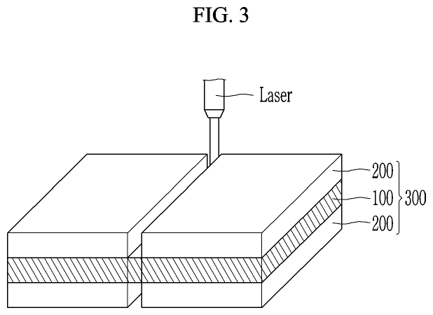

FIG. 3 illustrates a configuration of removal of the resin through laser irradiation. Referring to FIG. 3, the resin is removed along a laser irradiation line by irradiating a laser, and a groove is formed in the glass 100 or its properties are changed (S20). The resins 200 are removed by laser irradiation, but the glass 100 is not completely removed, and grooves are formed or not formed and physical properties may change.

FIG. 3 illustrates a configuration where grooves 110 are formed in the glass 100 after laser irradiation. As shown in FIG. 3, a plurality of grooves 110 may be formed in the glass 100 along the laser irradiation line.

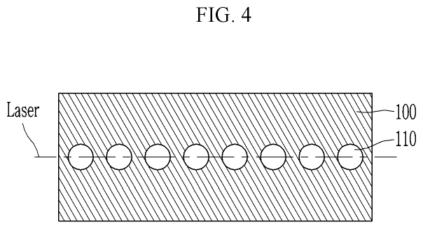

FIG. 4 illustrates a configuration where the physical properties of the glass 100 are changed after laser irradiation. As shown in FIG. 4, the physical property of the glass 100 may be changed along the laser irradiation line. In FIG. 4, an irradiation region 120 where the laser is irradiated in the glass 100 is illustrated. The physical properties of the irradiation region 120 to which the laser is irradiated are different from those of the other regions of the glass 100, and etching liquid can easily penetrate in subsequent processes such as chemical etching.

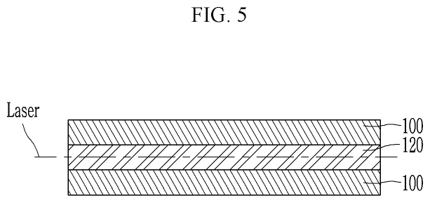

FIG. 5 illustrates a primary chemical etching process. Referring to FIG. 5, the laminate 300 where the laser is irradiated is primarily chemically etched (S30). As shown in FIG. 5, an etching liquid composition is contained in a chamber 700, and the laminate 300 moves in the chamber 700 and is exposed by the etching liquid composition. The etching liquid composition permeates into the grooves 110 formed in the glass 100 of the irradiation region 120 of which the physical properties are changed as shown in FIG. 4, and the glass 100 is etched and thus may be divided along the laser irradiation line.

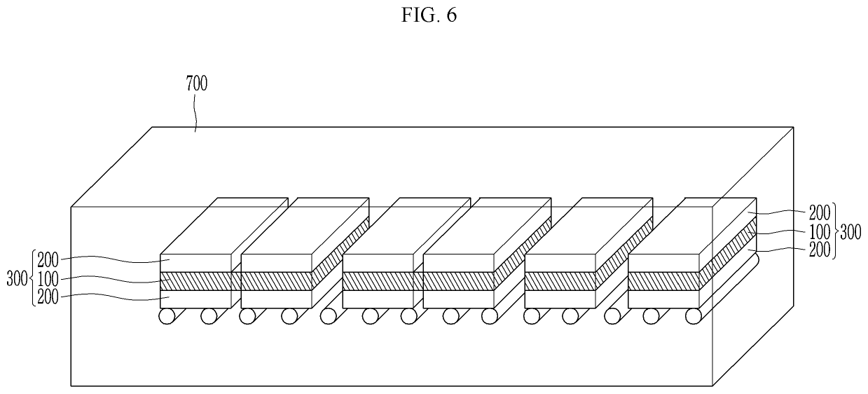

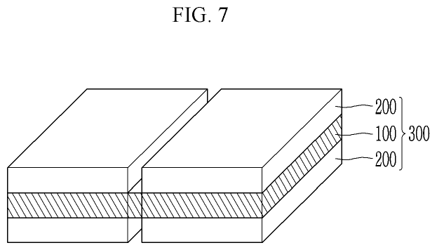

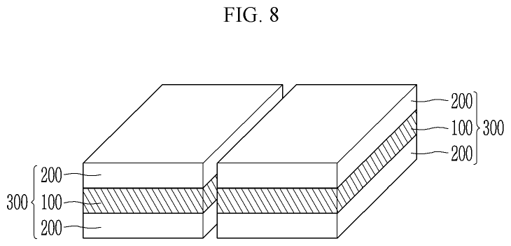

FIG. 6 illustrates the shape of the laminate when being injected into the chamber 700. The laminate 300 inserted into the chamber 700 that contains the etching solution composition in the state shown in FIG. 6 may be separated as shown in FIG. 7 by chemical etching in the chamber 700. FIG. 8 shows the shape of the laminate after the primary chemical etching. In this case, not only the glass 100 is separated by chemical etching, but also a curved surface may be formed on the side of the glass 100.

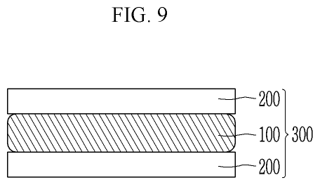

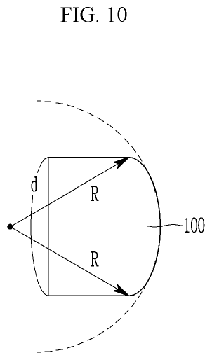

FIG. 9 shows the separated laminate 300 after the primary chemical etching. FIG. 10 illustrates only the glass 100 in the laminate 300 of FIG. 9. As shown in FIG. 9 and FIG. 10, the side of the glass 100 is curved after the primary chemical etching. This is because the side of the glass 100 is etched while the etching liquid composition penetrates during the first chemical etching process. Due to the primary etching, the glass 100 has the curved side as shown in FIG. 9 and FIG. 10. In this case, a curvature radius R of the curved surface may be larger than a thickness d of the glass 100.

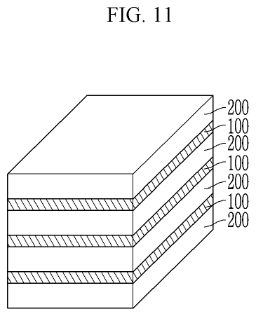

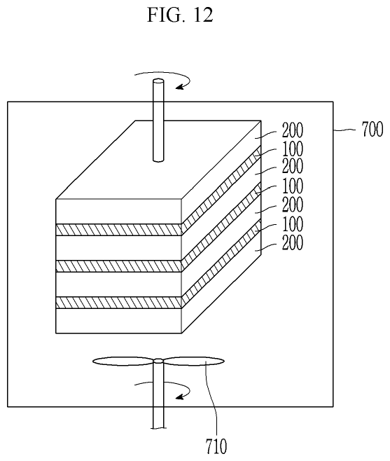

FIG. 11 illustrates a structure where a plurality of laminates are stacked. Referring to FIG. 11, a plurality of laminates are stacked (S40). FIG. 12 illustrates a secondary chemical spinning etching process. Referring to FIG. 12, the laminates 300 are secondarily etched through chemical spinning etching (S50). As shown in FIG. 12, the etching liquid composition is contained in the chamber 700, and the structure in which a plurality of laminates are stacked is rotated and etched. In this case, while the laminate is rotated, the etching liquid may also be rotated by a rotation blade 710 at the bottom.

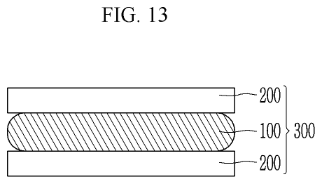

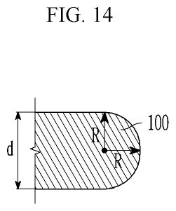

FIG. 13 illustrates the laminate 300 after the secondary chemical etching. FIG. 14 illustrates only the glass 100 in the laminate 300 of FIG. 13. As shown in FIG. 13 and FIG. 14, a curved surface is formed in the side of the glass 100 after the secondary chemical etching. Compared to the curved surface formed in FIG. 9 and FIG. 10, the curved surface of FIG. 13 and FIG. 14 has a smaller curvature radius.

As shown in FIG. 14, a curvature radius R of the curved surface of the glass 100 formed after the secondary chemical etching may be half of the thickness d of the glass 100. That is, as shown in FIG. 14, the curvature radius of the curved surface of the glass 100, which has been formed through the secondary etching after the primary etching, may have a curved surface through secondary etching, and may have a constant curvature or may be similar thereto. Specifically, a difference between a diameter 2R of the curved surface of the glass 100, formed after the secondary chemical etching, and the thickness d of the glass 100 may be within 10%.

When the curved surface of glass 100 is formed similarly to the constant curvature, the impact strength applied to the side can be increased.

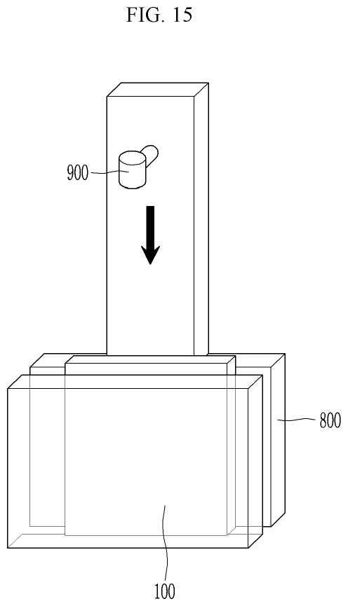

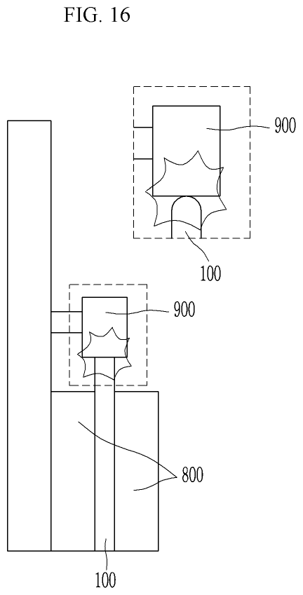

FIG. 15 simply illustrates a side impact damage test. As shown in FIG. 15, the glass 100 is placed in a guide member 800, and then an impact member 900 is dropped onto the side of the glass 100. FIG. 16 is a side view of the impact damage test. As shown in FIG. 16, when the impact member 900 falls on the side of the glass 100, the strength at which the glass 100 breaks can be measured.

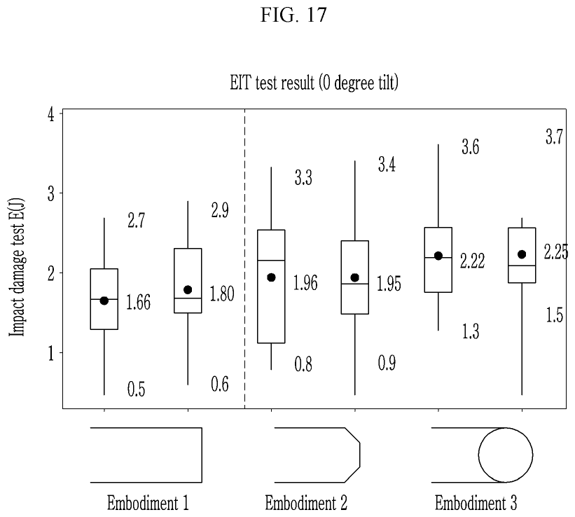

FIG. 17 illustrates results of the impact damage test of FIG. 15 and FIG. 16 performed on glass having various side shapes. As shown in FIG. 17, it was determined that as a side of a glass 100 was closer to the constant curvature (Embodiment 3), the strength against impact increased.

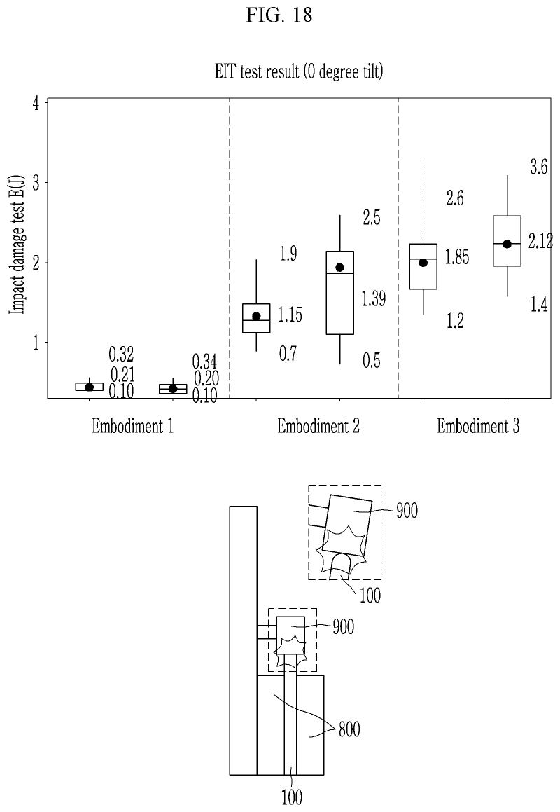

FIG. 18 illustrates the same experiment after tilting glasses, respectively having sides of Embodiment 1, Embodiment 2, and Embodiment 3, after tilting the glass at 10 degrees. A configuration in which the glass is tilted at an inclination of 10 degrees is schematically shown in FIG. 18. As shown in FIG. 18, it was determined that as a side of a glass 100 was closer to the constant curvature (Embodiment 3), the strength against impact increased.

That is, in the manufacturing method of glass according to an embodiment, the side of the glass 100 may have a curved surface close to the constant curvature through laser irradiation, primary etching, and secondary etching. Therefore, it is possible to increase the strength with respect to the side impact of the glass 100.

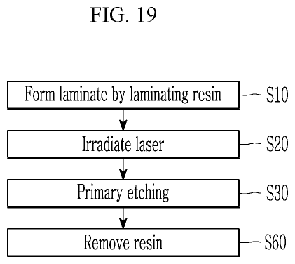

Hereinafter, a manufacturing method of glass according to another embodiment will be described. FIG. 19 is a flowchart that simply shows a manufacturing process of glass according to another embodiment. Referring to FIG. 19, a manufacturing method of glass according to an embodiment includes: forming a laminate by laminating a resin in upper and lower portions of glass (S10), removing the resin and forming a groove in the glass or changing physical properties by irradiating a laser (S20); cutting the laminate by performing primary chemical etching (S30); and removing the resin (S60).

The forming a laminate by laminating the resin in the upper and lower portions of the glass (S10), removing the resin and forming the groove in the glass or changing physical properties by irradiating the laser (S20); and cutting the laminate by performing primary chemical etching (S30) are the same as those according to the embodiment of FIG. 1. Detailed description of the same steps will be omitted for ease in explanation of this embodiment.

The manufacturing method according to the embodiment as shown in FIG. 19 is different from the embodiment of FIG. 1 in that the resin is removed after performing the primary chemical etching.

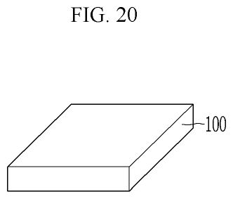

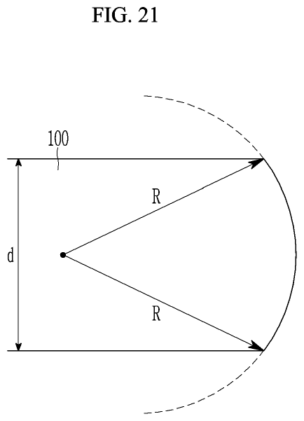

Referring to FIG. 20, a resin is removed from a primarily-etched laminate. In FIG. 20, a glass 100 from which the resin is removed is illustrated. FIG. 21 illustrates a side of the glass 100 manufactured according to the embodiment of FIG. 19. As shown in FIG. 21, a curvature radius of the side of the glass 100 manufactured according to the embodiment of FIG. 19 is larger than a curvature radius of the side of glass 100 manufactured according to the embodiment of FIG. 1. After the first etching according to the use environment, the glass 100 such as FIG. 21 can be manufactured and used.

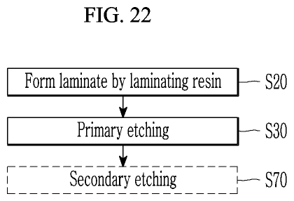

FIG. 22 is a flowchart of a manufacturing process of glass according to another embodiment. Referring to FIG. 22, a manufacturing process of glass according to the embodiment includes: forming a groove in the glass or changing physical properties by irradiating a laser (S20); and cutting the glass by performing primary chemical etching (S30). In addition, performing secondary chemical spinning etching (S70) may be further included.

The manufacturing method of the glass according to the embodiment of FIG. 22 may be the same as the manufacturing method according to the embodiment of FIG. 1, except that forming resins 200 in upper and lower portions of the glass 100 is omitted. A detailed description of the same constituent elements will be omitted.

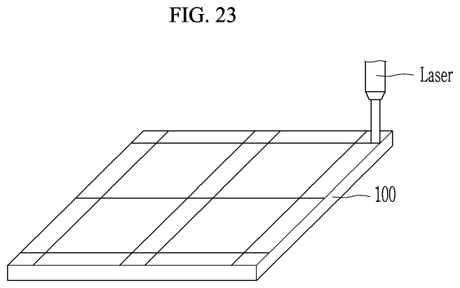

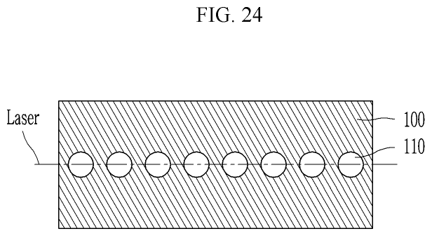

FIG. 23 illustrates a laser irradiation process. Referring to FIG. 23, a groove is formed on the glass or physical properties are changed by irradiating a laser (S20). FIG. 24 shows a configuration in which grooves 110 are formed in the glass 100 after the laser irradiation. As shown in FIG. 24, a plurality of grooves 110 may be formed in the glass 100 along a laser irradiation line.

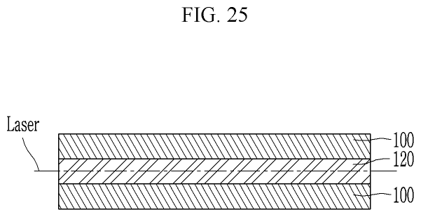

FIG. 25 shows a configuration of the glass 100 of which the physical properties are changed after laser irradiation. As shown in FIG. 25, the physical properties of the glass 100 may be changed along the laser irradiation line. In FIG. 25, an irradiation region 120 irradiated with a laser on the glass 100 is shown. The physical properties of the irradiation region 120 where the laser is irradiated is different from those of other regions of the glass 100, and an etching liquid may easily penetrate in a process such as chemical etching.

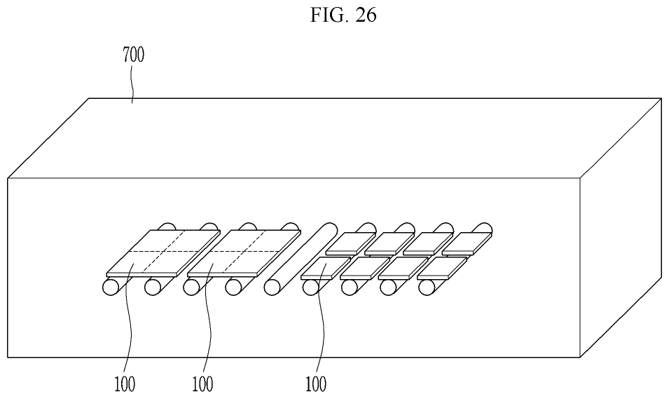

FIG. 26 illustrates a process of primary chemical etching. Referring to FIG. 26, the glass 100 to which the laser is irradiated is primarily chemically etched (S30). As shown in FIG. 26, an etching liquid composition is contained in a chamber 700, and the glass 100 moves in the chamber 700 and is exposed by the etching liquid composition. The etching liquid composition permeates into the grooves 110 formed in the glass 100 of the irradiation region 120 of which the physical properties are changed as shown in FIG. 24 and FIG. 25, and the glass 100 is etched and thus may be divided along the laser irradiation line.

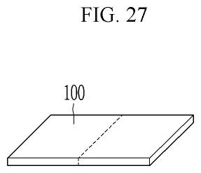

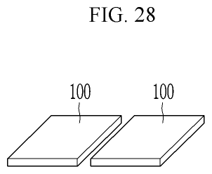

FIG. 27 illustrates the shape of the glass when being inserted into the chamber 700. FIG. 28 shows the shape of the glass after the primary chemical etching. The glass 100 inserted into the chamber 700 that contains the etching solution composition in the state shown in FIG. 27 may be separated as shown in FIG. 28 by chemical etching in the chamber 700. In this case, not only the glass 100 is separated by chemical etching, but also a curved surface may be formed on the side of the glass 100.

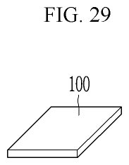

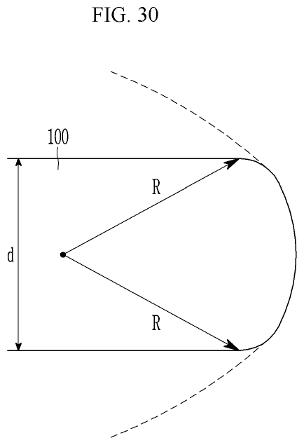

FIG. 29 shows separated glass 100 after the primary chemical etching. FIG. 30 illustrates the glass 100 of FIG. 29. As shown in FIG. 29 and FIG. 30, the side of the glass 100 is curved after the primary chemical etching. This is because the side of the glass 100 is etched while the etching liquid composition penetrates during the first chemical etching process. Due to the primary etching, the glass 100 has the curved side as shown in FIG. 29 and FIG. 30. In this case, a curvature radius R of the curved surface may be larger than a thickness d of the glass 100.

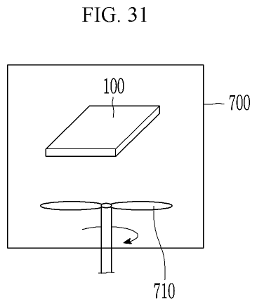

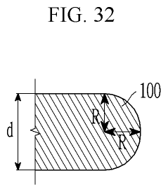

FIG. 31 illustrates a secondary etching process performed on the primarily etched glass. The secondary etching may be performed through spinning etching by a rotation blade 710 in the chamber 700. FIG. 32 illustrates the glass 100 after the secondary etching of FIG. 31. As shown in FIG. 32, a curvature radius R of the curved surface of the glass 100 formed after the secondary chemical etching may be half of the thickness d of the glass 100. That is, as shown in FIG. 32, the curvature radius of the curved surface of the glass 100, which has been formed through the secondary etching after the primary etching, may have a curved surface through secondary etching, may have a constant curvature or may be similar thereto. Specifically, a difference between a diameter 2R of the curved surface of the glass 100, formed after the secondary chemical etching, and the thickness d of the glass 100, may be within 10%.

When the curved surface of the glass 100 is formed similarly to the constant curvature, the impact strength applied to the side can be increased.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A manufacturing method of a display device, comprising:
forming a laminate by laminating resins on first and second side surfaces of a glass;
removing the resins along a laser irradiation line by irradiating a laser on the laminate;
separating the laminate into a plurality of laminates by performing primary etching using an etching liquid composition;
vertically stacking the plurality of laminates; and
performing secondary chemical etching on a structure formed by stacking the plurality of laminates.

2. The manufacturing method of the display device of claim 1, wherein in the removing of the resins by irradiating the laser on the laminate,
a plurality of grooves are formed on the glass along the laser irradiation line.

3. The manufacturing method of the display device of claim 1, wherein in the removing of the resins by irradiating the laser on the laminate,
physical properties of the glass are changed along the laser irradiation line.

4. The manufacturing method of the display device of claim 1, wherein, after the separating the laminate into a plurality of laminates by primary etching the laminate using the etching liquid composition,
a curvature radius of the first and second side surfaces of the glass is larger than a curvature radius of the first and second side surfaces of the glass after the secondary chemical etching is performed on the structure on which the plurality of laminates are stacked.

5. The manufacturing method of the display device of claim 1, wherein in the separating the laminate into the plurality of laminates through primary etching by using the etching liquid composition,
a curvature radius of the first and second side surfaces of the glass is larger than a thickness of the glass.

6. The manufacturing method of the display device of claim 1, wherein, after the performing of the secondary chemical etching on the structure formed by stacking the plurality of laminates,
a difference between a curvature radius of the first and second side surfaces of the glass and a thickness of the glass is within 10%.

7. The manufacturing method of the display device of claim 1, wherein a thickness of the glass is about 30 μm to about 100 μm.

8. The manufacturing method of the display device of claim 1, further comprising, after the performing of the secondary chemical etching on the structure formed by stacking the plurality of laminates,
separately separating the glass by removing the resin from the structure.

9. A manufacturing method of a display device, comprising:
forming a laminate by laminating resins on first and second side surfaces of a glass;
removing the resins along a laser irradiation line by irradiating a laser on the laminate;
separating the laminate into a plurality of laminates by performing primary etching using an etching liquid composition; and
removing the resin from the laminate.

10. The manufacturing method of the display device of claim 9, wherein in the removing of the resins by irradiating the laser on the laminate,
a plurality of grooves are formed on the glass along the laser irradiation line.

11. The manufacturing method of the display device of claim 9, wherein in the removing of the resins by irradiating the laser on the laminate,
physical properties of the glass are changed along the laser irradiation line.

12. The manufacturing method of the display device of claim 9, wherein in the separating the laminate into the plurality of laminates through primary etching by using the etching liquid composition,
a curvature radius of the first and second side surfaces of the glass is larger than a thickness of the glass.

13. The manufacturing method of the display device of claim 9, wherein a thickness of the glass is about 30 μm to about 100 μm.

14. A manufacturing method of a display device, comprising:
irradiating a glass with a laser; and
separating the glass irradiated with the laser into a plurality of pieces by performing etching using an etching liquid composition.

15. The manufacturing method of the display device of claim 14, wherein in the irradiating the glass with the laser,
a plurality of grooves are formed in the glass along a laser irradiation line.

16. The manufacturing method of the display device of claim 15, wherein in the irradiating the laser on the glass,
physical properties of the glass are changed along the laser irradiation line.

17. The manufacturing method of the display device of claim 14, further comprising, after the separating the glass into the plurality of pieces by etching the laser-irradiated glass with the etching liquid composition,
performing secondary etching on the separated individual glass.

18. The manufacturing method of the display device of claim 17, wherein, after performing the secondary etching on the separated individual glass,
a difference between a curvature radius of a side surface of the glass and a thickness of the glass is within 10%.

19. The manufacturing method of the display device of claim 17, wherein the separated individual glass is secondarily etched by spinning etching.

20. The manufacturing method of the display device of claim 14, wherein a thickness of the glass is about 30 μm to about 100 μm.
